(19) United States
(12) Patent Application Publication
(10) Pub. No.: US 2026/0320786 A1
(43) Pub. Date: Oct. 15, 2026

(54) AUTOMATIC REGION OF INTEREST SELECTION FOR IMAGING BASED URINE ANALYZERS

(71) Applicant: Siemens Healthcare Diagnostics Inc., Tarrytown, NY (US)

(72) Inventors: Vaishnav Ram Savarni K R, Bangalore (IN); Sudipa Bhattacharya, Bangalore (IN); Lloyd Schulman, Granger, IN (US); Emma Orton, Cranston, RI (US)

(73) Assignee: Siemens Healthcare Diagnostics Inc., Tarrytown, NY (US)

(21) Appl. No.: 19/484,341

(22) PCT Filed: May 10, 2024
(86) PCT No.: PCT/US2024/028710

§ 371 Date: Nov. 13, 2025

Related U.S. Application Data
(60) Provisional application No. 63/502,239, filed on May 15, 2023.

(51) Int. Cl. G06T 7/00; G06T 7/73

(52) U.S. Cl. CPC G06T 7/0012; G06T 7/73; G06T 2207/10024

(57) ABSTRACT

Methods and systems for automatically selecting a region of interest in an image captured by an optical inspection apparatus are herein disclosed. One method comprises analyzing pixels within an image of a liquid sample carrier to determine a location of an indicator within the image, determining a reading area position of a reading area of the liquid sample carrier within the image based on the location of the indicator determined by analyzing pixels within the image, and analyzing pixels within the image depicting the reading area to determine a presence and/or absence of a predetermined analyte in a liquid sample disposed on the liquid sample carrier. The liquid sample carrier may be a reagent strip or a reagent cassette. The indicator may be a fiducial, a symbol, a colored region, or a material configured to appear different when exposed to a particular wavelength of the electromagnetic spectrum.

### CROSS-REFERENCE TO RELATED APPLICATIONS

The present patent application claims priority to U.S. Ser. No. 63/502,239, filed on May 15, 2023, the entire content of which is hereby incorporated herein by reference.

### FEDERALLY SPONSORED RESEARCH AND DEVELOPMENT

Not Applicable.

### BACKGROUND ART

A convenient way to screen and monitor patients for disease is to perform a point-of-care in-vitro test using a bodily fluid such as blood, urine, saliva, sputum, etc. Of such bodily fluids, urine is a particularly important bodily fluid because it contains major physiological and pathological information. Further, the ease with which samples may be collected makes urine convenient for taking multiple samples, performing test screening, monitoring for disease, and drawing conclusive inferences. For example, analyzing patient urine samples may allow one to draw preliminary conclusions in diagnosing, for example, urinary tract infections, diabetes, and kidney and liver diseases.

Usually, analyzing a urine sample involves dipping a strip of dry reagent pads into the sample. Such tests are usually colorimetric; that is, the reagent pads change color based on a concentration of a particular analyte present in the sample. These color changes are usually visually inspected by a human expert. However, a visual inspection performed by a human may be error-prone, subjective, and time-consuming. In order to overcome such limitations, an automatic urine analyzing instrument may be used. One such instrument may include a camera sensor, a processor, and an illumination source such that the instrument is capable of extracting clinical information from the color changes of the reagent pads.

### SUMMARY OF THE INVENTION

In one aspect, the present disclosure is directed to a method, comprising: analyzing, by a processor, pixels within an image of a liquid sample carrier to determine a location of an indicator within the image, the liquid sample carrier having a liquid sample disposed thereon; determining, by the processor, a reading area position of a reading area of the liquid sample carrier within the image based at least in part on the location of the indicator determined by analyzing pixels within the image; and analyzing, by the processor, pixels within the image depicting the reading area to determine a presence and/or absence of a predetermined analyte in the liquid sample.

In another aspect, the present disclosure is directed to an optical inspection apparatus, comprising: a housing having an interior encompassing an inspection location; an indicator located within the inspection location; a light source configured to illuminate the inspection location within the housing; a tray assembly configured to receive a liquid sample carrier, the tray assembly being insertable within the inspection location of the housing; a sensor configured to capture an image of the inspection location of the housing including the indicator; and a controller having a processor operable to execute processor-executable code that when executed by the processor causes the processor to: analyze pixels within the image captured by the sensor to determine a location of the indicator within the image; determine a reading area position of a reading area within the image based at least in part on the location of the indicator determined by analyzing pixels within the image; and analyze pixels within the reading area of the image to determine a presence and/or absence of a predetermined analyte.

In yet another aspect, the present disclosure is directed to an optical inspection apparatus, comprising: a housing having an interior encompassing an inspection location; a liquid sample carrier having an indicator; a light source configured to illuminate the inspection location within the housing; a tray assembly receiving the liquid sample carrier, the tray assembly being insertable within the inspection location of the housing; a sensor configured to capture an image of the inspection location of the housing including the indicator; and a controller having a processor operable to execute processor-executable code that when executed by the processor causes the processor to: analyze pixels within the image captured by the sensor to determine a location of the indicator within the image; determine a reading area position of a reading area within the image based at least in part on the location of the indicator determined by analyzing pixels within the image; and analyze pixels within the reading area of the image to determine a presence and/or absence of a predetermined analyte.

### BRIEF DESCRIPTION OF THE DRAWINGS

The accompanying drawings, which are incorporated in and constitute a part of this specification, illustrate one or more implementations described herein and, together with the description, explain these implementations. The drawings are not intended to be drawn to scale, and certain features and certain views of the figures may be shown exaggerated, to scale or in schematic in the interest of clarity and conciseness. Not every component may be labeled in every drawing. Like reference numerals in the figures may represent and refer to the same or similar element or function. In the drawings:

FIG. 1 is a perspective view of an optical inspection apparatus constructed in accordance with the present disclosure, which may be used to perform various tests of a bodily fluid sample;

FIG. 2 is a block diagram of circuitry of the optical inspection apparatus shown in FIG. 1;

FIG. 3 is a perspective view of a reagent strip for inspection by the optical inspection apparatus shown in FIG. 1;

FIG. 4 is a perspective view of a reagent cassette for inspection by the optical inspection apparatus shown in FIG. 1;

FIG. 5 is an exploded perspective view of a tray assembly constructed in accordance with the present disclosure for use with the optical inspection apparatus shown in FIG. 1, wherein an insert is shown being positioned in a support tray with a first surface facing upwardly so that a reagent strip may be held by the insert;

FIG. 6 is an exploded perspective view of a tray assembly constructed in accordance with the present disclosure for use with the optical inspection apparatus shown in FIG. 1, wherein an insert is shown being positioned in a support tray with a second surface facing upwardly so that a reagent cassette may be held by the insert;

FIG. 7 is a perspective view of a portion of the tray assembly shown in FIG. 5, wherein the insert is shown being positioned in the support tray with the first surface facing upwardly;

FIG. 8 is a perspective view of a portion of the support tray of the assembly shown in FIG. 6;

FIG. 9 is a perspective view of the insert of the tray assembly shown in FIG. 5;

FIG. 10 is a perspective view of another tray assembly constructed in accordance with the present disclosure for use with the optical inspection apparatus shown in FIG. 1, wherein an insert is shown being positioned in a support tray in a first position so that a reagent strip may be held by the insert;

FIG. 11 is another perspective view of the tray assembly shown in FIG. 10, wherein the insert is shown being positioned in the support tray in a second position so that a reagent cassette may be held by the support tray;

FIG. 12 is a perspective view of another tray assembly constructed in accordance with the present disclosure for use with the optical inspection apparatus shown in FIG. 1, wherein an insert is shown being positioned in a support tray in a first position so that a reagent strip may be held by the insert;

FIG. 13 is another perspective view of the tray assembly shown in FIG. 12, wherein an insert is shown being positioned in the support tray so that a reagent cassette may be held by the support tray;

FIG. 14 is a process flow diagram of a method for optically inspecting a liquid sample disposed on a liquid sample carrier;

FIG. 15 is an exemplary image captured by the optical inspection apparatus shown in FIG. 1, wherein the image shows a reagent strip being held by the insert;

FIG. 16 is another exemplary screenshot of an image captured by the optical inspection apparatus shown in FIG. 1, wherein the image shows a reagent cassette being held by the insert, the reagent cassette having one or more symbol disposed on an upper surface thereof;

FIG. 17 is another exemplary screenshot of an image captured by the optical inspection apparatus shown in FIG. 1, wherein the image shows a reagent cassette being held by the insert, the reagent cassette having a material configured to appear different when illuminated by a particular wavelength of the electromagnetic spectrum disposed on an upper surface thereof;

FIG. 18 is another exemplary screenshot of an image captured by the optical inspection apparatus shown in FIG. 1, wherein the image shows a reagent cassette being held by the insert, the reagent cassette having a colored region having a predetermined color value disposed on an upper surface thereof;

FIG. 19 is an exemplary screenshot of a one-dimensional gradient representation of the image shown in FIG. 15;

FIG. 20 is an exemplary screenshot of a template gradient representation for correlation with the one-dimensional gradient representation shown in FIG. 19; and

FIG. 21 is an exemplary screenshot of a zoomed-in and inverted portion of the one-dimensional gradient representation shown in FIG. 19.

### DETAILED DESCRIPTION

Before explaining at least one embodiment of the inventive concept(s) in detail by way of exemplary language and results, it is to be understood that the inventive concept(s) is not limited in its application to the details of construction and the arrangement of the components set forth in the following description. The inventive concept(s) is capable of other embodiments or of being practiced or carried out in various ways. As such, the language used herein is intended to be given the broadest possible scope and meaning; and the embodiments are meant to be exemplary—not exhaustive. Also, it is to be understood that the phraseology and terminology employed herein is for the purpose of description and should not be regarded as limiting.

Headings are provided for convenience only and are not to be construed to limit the invention in any manner. Embodiments illustrated under any heading or in any portion of the disclosure may be combined with embodiments illustrated under the same or any other heading or other portion of the disclosure. Any combination of the elements described herein in all possible variations thereof is encompassed by the invention unless otherwise indicated herein or otherwise clearly contradicted by context.

Unless otherwise required by context, singular terms shall include pluralities and plural terms shall include the singular, with the exception that the term “plurality” as used herein, does not include the singular.

All patents or published patent applications referenced in any portion of this application are herein expressly incorporated by reference in their entirety to the same extent as if each individual patent or publication was specifically and individually indicated to be incorporated by reference.

All of the assemblies, systems, kits, and/or methods disclosed herein can be made and executed without undue experimentation in light of the present disclosure. Where a method claim does not specifically state in the claims or description that the steps are to be limited to a specific order, it is in no way intended that an order be inferred, in any respect. This holds for any possible non-express basis for interpretation, including matters of logic with respect to arrangement of steps or operational flow, plain meaning derived from grammatical organization or punctuation, or the number or type of embodiments described in the specification.

As utilized in accordance with the present disclosure, the following terms, unless otherwise indicated, shall be understood to have the following meanings:
The use of the term “a” or “an” when used in conjunction with the term “comprising” in the claims and/or the specification may mean “one,” but it is also consistent with the meaning of “one or more,” “at least one,” and “one or more than one.” The term “plurality” refers to “two or more.”
The use of the term “at least one” will be understood to include one as well as any quantity more than one. In addition, the use of the term “at least one of X, Y, and Z” will be understood to include X alone, Y alone, and Z alone, as well as any combination of X, Y, and Z.
The use of ordinal number terminology (i.e., “first,” “second,” “third,” “fourth,” etc.) is solely for the purpose of differentiating between two or more items and is not meant to imply any sequence or order or importance to one item over another or any order of addition, for example.
The use of the term “or” in the claims is used to mean an inclusive “and/or” unless explicitly indicated to refer to alternatives only or unless the alternatives are mutually exclusive.

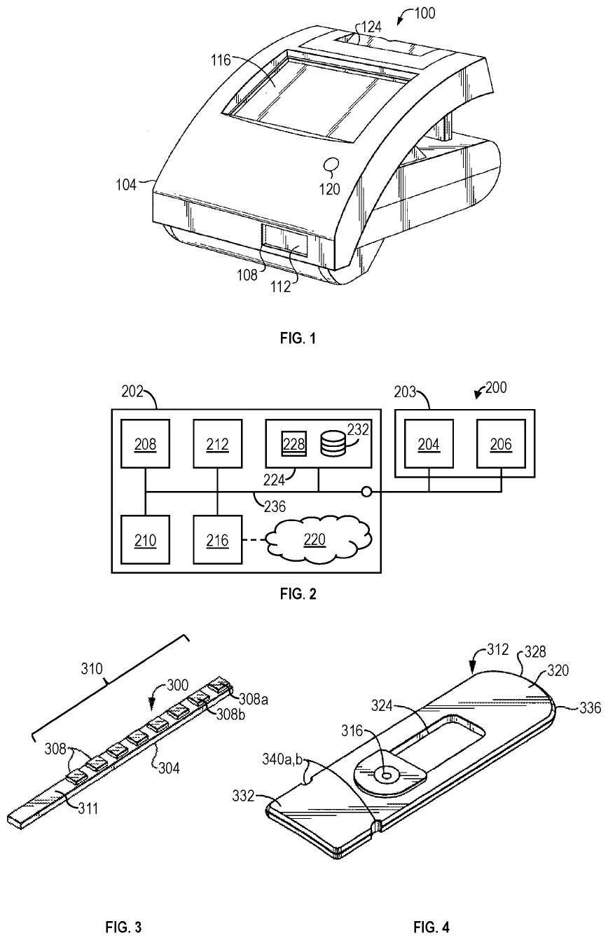

Referring now to the drawings and in particular to FIG. 1, shown therein is an optical inspection apparatus 100 (hereinafter the “apparatus 100”) constructed in accordance with the present disclosure. In some implementations, the apparatus 100 may include an optical reflectance- or absorbance-based reader 203 (hereinafter the “reader 203”) (shown in FIG. 2) for optically inspecting liquid samples, such as bodily fluid samples, placed on a liquid sample carrier, such as a reagent strip 300 (shown in FIG. 3) or a reagent cassette 312 (shown in FIG. 4). In one version, the reader 203 is a reflectance spectroscope.

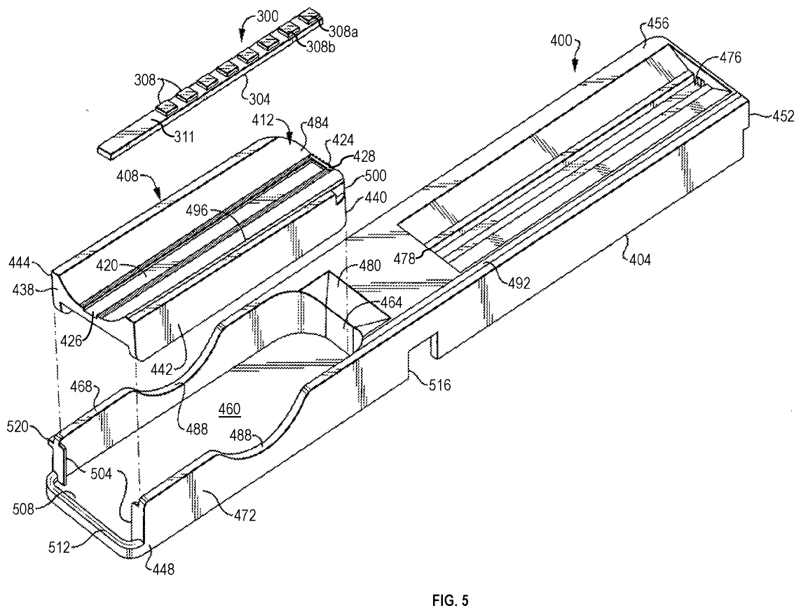

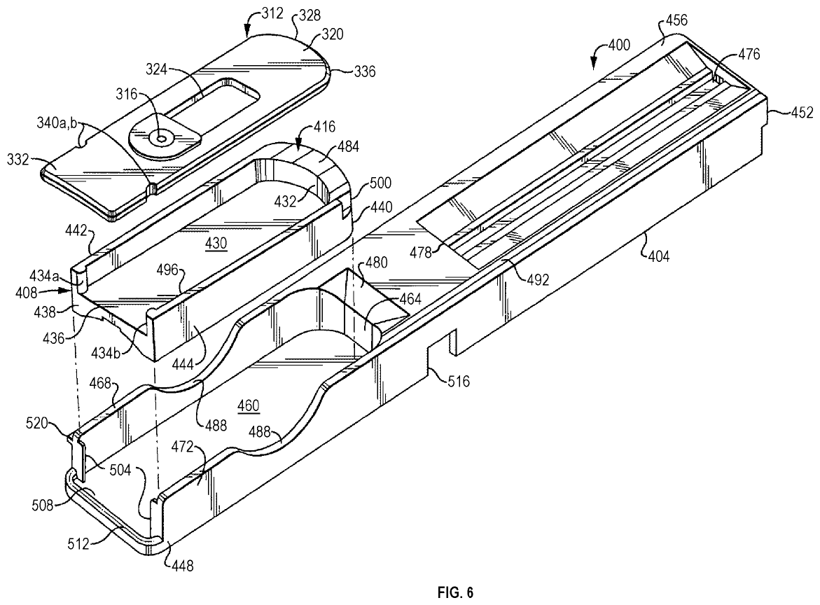

The apparatus 100 may comprise: a housing 104 having an interior encompassing an inspection location, the housing 104 has an opening 108 formed therein into which a tray assembly 400 (shown in FIGS. 5-6) may be passed; a door 112 in the opening 108 which may open upon the tray assembly 400 being extended out of the opening 108; a touch-screen display 116 for user input and displaying various messages to the user relating to the operation of the apparatus 100 (e.g., test results); and a start button 120. The inspection location may be the location where the reagent strip 300 and/or the reagent cassette 312 is to be positioned within the housing 104.

As discussed further below, the tray assembly 400 may be adapted to receive a liquid sample carrier, such as the reagent strip 300 or the reagent cassette 312. The user may then press one of the touch-screen display 116 and the start button 120 to cause a controller 202 (shown in FIG. 2)—which may be contained within the housing 104 or remote from the apparatus 100—to move the tray assembly 400 inwardly toward the inspection location to perform an optical inspection.

In use, a user may prepare a liquid sample carrier, such as the reagent strip 300 or the reagent cassette 312, for optical inspection by placing a bodily fluid sample on the liquid sample carrier and placing the liquid sample carrier in the tray assembly 400. The user may then press one of the touch-screen display 116 and/or the start button 120 to cause the controller 202 to retract the tray assembly 400 inwardly so that a light source 204 (shown in FIG. 2) disposed within the housing 104 of the apparatus 100 may illuminate the inspection location within the housing 104 (including a reading area of the liquid sample carrier), and a sensor 206 (shown in FIG. 2) disposed within the housing 104 of the apparatus 100 may capture one or more image of the illuminated liquid sample carrier. In some implementations, the sensor 206 may capture a time-based sequence of images of the illuminated liquid sample carrier. As discussed further below, the reading area of the liquid sample carrier may be a reagent pad 308 (shown in FIG. 3) or a reagent pad area 310 (shown in FIG. 3) of the reagent strip 300 or a window 324 (shown in FIG. 4) of the reagent cassette 312.

Referring now to FIG. 2, shown therein is circuitry 200 constructed in accordance with the present disclosure. The circuitry 200 may be contained within the housing 104 of the apparatus 100 and may comprise the controller 202 and the reader 203 comprising the light source 204 and the sensor 206. The light source 204 may be configured to illuminate the inspection location within the housing 104. The sensor 206 may be configured to capture one or more image of the inspection location of the housing 104 as discussed in more detail below. Exemplary sensors 206 include: charge-couple device sensor(s); complementary metal-oxide semiconductor sensor(s); ultraviolet sensor(s); infrared sensor(s); and combinations thereof. The light source 204 may be implemented as a device that emits photons when actuated by the processor 212. Exemplary light sources 204 include: incandescent bulb(s); fluorescent lamp(s); light emitting diode(s); halogen lamp(s); neon lamp(s); gas-discharge lamp(s); and combinations thereof.

In some implementations, the controller 202 may include, but is not limited to, implementations as a personal computer, a cellular telephone, a smart phone, a network-capable television set, a tablet, a laptop computer, a desktop computer, a network-capable handheld device, a server, a digital video recorder, a wearable network-capable device, a virtual reality/augmented reality device, and/or the like.

In some implementations, the controller 202 may include one or more input device 208 (hereinafter the “input device 208”), one or more output device 210 (hereinafter the “output device 210”), one or more processor 212 (hereinafter the “processor 212”), one or more communication device 216 (hereinafter the “communication device 216”) capable of interfacing with a communication network 220, and one or more non-transitory computer-readable medium 224 (hereinafter the “controller memory 224”) storing processor-executable code and/or one or more software application 228 (hereinafter the “software application 228”) and a database 232, for example including, a web browser capable of accessing a website and/or communicating information and/or data over a wireless or wired network (e.g., the communication network 220), and/or the like. The input device 208, the output device 210, the processor 212, the communication device 216, and the controller memory 224 may be connected via a path 236 such as a data bus that permits communication among the components of the controller 202.

In some implementations, the processor 212 may comprise one or more processor 212 working together, or independently, to read and/or execute processor-executable code and/or data, such as stored in the controller memory 224. The processor 212 may be capable of creating, manipulating, retrieving, altering, and/or storing data structures into the controller memory 224. The processor 212 executing the software application 228 stored in the controller memory 224 may become a special-purpose machine particularly suited for performing various actions, operations, analyses, and/or the like in accordance with the systems and methods described herein and illustrated in the FIGS. Each element of the controller 202 may be partially or completely network-based or cloud-based, and may or may not be located in a single physical location.

Exemplary implementations of the processor 212 may include, but are not limited to, a digital signal processor (DSP), a central processing unit (CPU), a field programmable gate array (FPGA), a microprocessor, a multi-core processor, an application specific integrated circuit (ASIC), combinations, thereof, and/or the like, for example. The processor 212 may be capable of communicating with the controller memory 224 via the path 236. The processor 212 may be capable of communicating with the input device 208 and/or the output device 210 via the path 236.

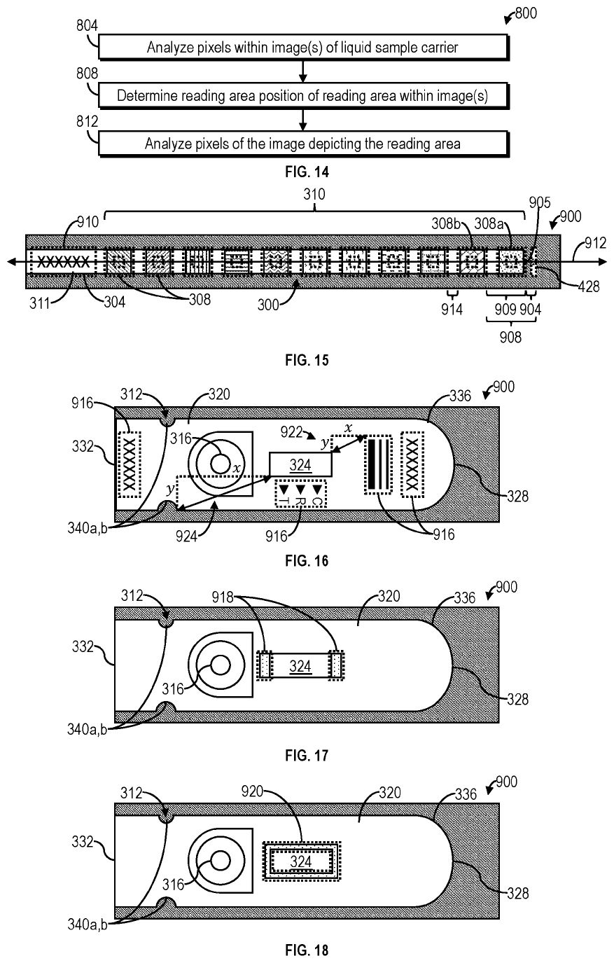

The software application 228, when executed by the processor 212, may cause the controller 202 to perform, for example, a method 800 (shown in FIG. 14) and/or perform an action such as communicate with, or control, one or more component of the apparatus 100, the controller 202, and/or the communication network 220.

In some implementations, the controller memory 224 may be located in the same physical location as the controller 202, and/or one or more controller memory 224 may be located remotely from the controller 202. For example, the controller memory 224 may be located remotely from the controller 202 and communicate with the processor 212 via the communication network 220. Additionally, when more than one controller memory 224 is used, a first controller memory 224 may be located in the same physical location as the processor 212, and one or more additional controller memory 224 may be located in a location physically remote from the processor 212. Additionally, the controller memory 224 may be implemented as a “cloud” non-transitory processor-readable storage memory (i.e., one or more of the controller memory 224 may be partially or completely based on or accessed using the communication network 220).

In one implementation, the database 232 may be a time-series database, a relational database, or a non-relational database. Examples of such databases comprise DB2®, Microsoft® Access, Microsoft® SQL Server, Oracle®, MySQL, PostgreSQL, MongoDB, Apache Cassandra, InfluxDB, Prometheus, Redis, Elasticsearch, TimescaleDB, and/or the like. It should be understood that these examples have been provided for the purposes of illustration only and should not be construed as limiting the presently disclosed inventive concepts. The database 232 may be centralized or distributed across multiple systems.

The input device 208 may be capable of receiving information input from the user, another computer, and/or the processor 212, and transmitting such information to other components of the controller 202 and/or the communication network 220. The input device 208 may include, but is not limited to, the start button 120, the touch-screen display 116, a keyboard, a touchscreen, a mouse, a trackball, a microphone, a camera, a fingerprint reader, an infrared port, a slide-out keyboard, a flip-out keyboard, a cell phone, a PDA, a remote control, a fax machine, a wearable communication device, a network interface, combinations thereof, and/or the like, for example.

The output device 210 may be capable of outputting information in a form perceivable by the user, another controller, and/or the processor 212. For example, implementations of the output device 210 may include, but are not limited to, the touch-screen display 116, a computer monitor, a screen, a touchscreen, a speaker, a website, a television set, a smart phone, a PDA, a cell phone, a fax machine, a printer, a laptop computer, a haptic feedback generator, a network interface, combinations thereof, and the like, for example. It is to be understood that in some exemplary implementations, the input device 208 and the output device 210 may be implemented as a single device, such as, for example, the touch-screen display 116, or a touch screen of a computer, a tablet, or a smartphone. It is to be further understood that as used herein the term “user” is not limited to a human being and may comprise a computer, a server, a website, a processor, a network interface, a user terminal, a virtual computer, combinations thereof, and/or the like, for example.

Referring now to FIG. 3, shown therein is a perspective view of the reagent strip 300 constructed in accordance with the present disclosure. The reagent strip 300 may have a thin, non-reactive substrate 304 (hereinafter the “substrate 304”) on which the reagent pads 308 are fixed in the reagent pad area 310. Each reagent pad 308 may be composed of a relatively absorbent material (e.g., cellulose-based materials, such as paper, cotton, and nitrocellulose membranes; glass fiber; and/or polyester) impregnated with a respective (i.e., different) reagent, each reagent and reagent pad 308 being associated with a particular test to be performed based on the reagent used. When each reagent pad 308 comes into contact with a bodily fluid sample, the reagent pad 308 may change color over a time period, depending on the reagent used and the characteristics of the bodily fluid sample.

As further described below, in some implementations, each reagent pad 308 is a separate reading area of the reagent strip 300 for purposes of optical inspection by the processor 212 of the apparatus 100 shown in FIG. 1; in other implementations, however, the entirety of the reagent pad area 310 is the reading area of the reagent strip 300 for purposes of optical inspection by the processor 212 of the apparatus 100 shown in FIG. 1. In some implementations, an upper surface 311 of the substrate 304 of the reagent strip 300 has one or more character or symbol 910 (hereinafter “symbols 910”) (shown in FIG. 15) printed, engraved, or otherwise disposed thereon.

Referring now to FIG. 4, shown therein is a perspective view of the reagent cassette 312 constructed in accordance with the present disclosure. The reagent cassette 312 may be a disposable, single-use cassette for performing a pregnancy test, for example, in a conventional manner. The reagent cassette 312 may have an opening or well 316 (hereinafter the “well 316”) formed in an upper surface 320 into which a bodily fluid sample is placed. The interior of the reagent cassette 312 may have the reagent strip 300 which may react to the bodily fluid sample placed in the well 316. Depending on the results of the test, the reagent strip 300 may change color (e.g., a colored stripe may appear), which may be determinable from viewing the reagent strip 300 through the window 324 formed in the upper surface 320 of the reagent cassette 312. The reagent cassette 312 may comprise first and second portions 328, 332, the first portion 328 having a curved end wall 336, and the first and second portions 328, 332 being separated by indents 340a, 340b.

As further described below, the window 324 may be the reading area of the reagent cassette 312 for purposes of optical inspection by the processor 212 of the apparatus 100 shown in FIG. 1. In some implementations, the upper surface 320 of the reagent cassette 312 may have one or more character or symbol 916 (hereinafter “symbols 916”) (shown in FIG. 16) printed, engraved, or otherwise disposed thereon. Alternatively or additionally, as shown in FIG. 17, the upper surface 320 of the reagent cassette 312 may have a luminescent material 918 (i.e., a material that appears different when exposed to particular wavelengths of the electromagnetic spectrum) disposed thereon. Alternatively or additionally, as shown in FIG. 18, the upper surface 320 of the reagent cassette 312 may have a colored region 920 having a predetermined color value disposed thereon. The processor 212 of the apparatus 100 may use one or more of the symbols 916, the luminescent material 918, and the colored region 920 as an indicator for determining a position of the reading area of the reagent cassette 312, as explained below.

While the systems and methods described herein are described as they relate to performing bodily fluid analysis tests, and particularly urinalysis tests, it will be understood by persons having ordinary skill in the art that the benefits and advantages described herein are applicable to performing any type of optical fluid analysis tests. When urinalysis tests are performed, they may include, for example, a test for leukocytes in the urine, a test of the pH of the urine, a test for blood in the urine, etc.

Referring now to FIGS. 5 and 6, shown therein is a perspective view of the tray assembly 400 constructed in accordance with the present disclosure for use with the apparatus 100 shown in FIG. 1. As discussed above, the tray assembly 400 may be adapted to receive either the reagent strip 300 or the reagent cassette 312; that is, the tray assembly 400 may comprise a support tray 404 and an insert 408 that fits into the support tray 404, wherein the insert 408 is provided with a first surface 412 (shown in FIG. 5) adapted to hold the reagent strip 300 and a second surface 416 (shown in FIG. 6) adapted to hold the reagent cassette 312. The first surface 412 and the second surface 416 may be disposed on opposing sides of the insert 408. In FIG. 5, the tray assembly 400 is shown with the first surface 412 of the insert 408 facing upwardly so that the reagent strip 300 may be held by the insert 408 in the support tray 404, and in FIG. 6, the tray assembly 400 is shown with the second surface 416 facing upwardly so that the reagent cassette 312 may be held by the insert 408 in the support tray 404. Accordingly, a user may choose to place the insert 408 into the support tray 404 with either the first surface 412 or the second surface 416 facing upwardly, depending on whether the user wishes to optically inspect the reagent strip 300 or the reagent cassette 312.

The first surface 412 of the insert 408 may have an elongated channel 420 sized to accommodate the reagent strip 300. The elongated channel 420 may be recessed with respect to the remaining portion of the first surface 412 such that, when the reagent strip 300 is held by the insert 408, the substrate 304 of the reagent strip 300 may be flush with the remaining (i.e., non-recessed) portion of the first surface 412. The first surface 412 of the insert 408 may also have an end wall 424 closing the elongated channel 420 at an end of the insert 408. A top surface 428 (hereinafter the “fiducial 428”) of the end wall 424 may be white (or another suitable color designed to be captured (e.g., having a different color than a background) in an image and detected by the processor 212. The processor 212 of the apparatus 100 shown in FIG. 1 may use the end wall 424 to determine, for example, whether the reagent strip 300 is correctly abutting the end wall 424 during an inspection procedure. As further described below, the processor 212 of the apparatus 100 may also use the fiducial 428 as an indicator for determining a position of the reading area of the reagent strip 300. The elongated channel 420 may have an open end 426 such that the reagent strip 300 may be slidingly inserted into the insert 408. Referring to FIG. 6, the second surface 416 of the insert 408 may have a recess 430 shaped to receive the first portion 328 of the reagent cassette 312. An end wall 432 of the recess 430 of the second surface 416 of the insert 408 may be curved to match the curved end wall 336 of the first portion 328 of the reagent cassette 312 to ensure that a user correctly orients the reagent cassette 312 within the insert 408. The insert 408 may include protrusions or bosses 434a, 434b at an open end 436 of the recess 430 that are received in, respectively, the indents 340a, 340b in the reagent cassette 312 to prevent the reagent cassette 312 from sliding out of the insert 408. Alternatively, the bosses 434a, 434b may be provided on the reagent cassette 312 and the indents 340a, 340b in the insert 408. The second portion 332 of the reagent cassette 312 may extend outwardly beyond the open end 436 of the recess 430 when the reagent cassette 312 is correctly positioned within the insert 408 such that only the first portion 328 is positioned in the recess 430. The second portion 332 of the reagent cassette 312 may be separated from the first portion 328 of the reagent cassette 312 by the indents 340a, 340b of the reagent cassette 312.

As is noticeable in FIG. 6, the second portion 332 of the reagent cassette 312 may be shorter than the first portion 328 of the reagent cassette 312 to further ensure that a user correctly orients the reagent cassette 312 within the insert 408. In addition, the bosses 434a, 434b of the recess 430 may be provided in slightly different sizes or shapes, and the indents 340a, 340b of the reagent cassette 312 also may be provided in slightly different sizes or shapes which match the bosses 434a, 434b to prevent the reagent cassette 312 from being inserted into the insert 408 upside down.

The first and second surfaces 412, 416 of the insert 408 may face in opposite directions and the insert 408 may also include first and second opposing ends 438, 440 connecting the first and second surfaces 412, 416 and first and second opposing sides 442, 444 connecting the first and second surfaces 412, 416 and extending between the first and second opposing ends 438, 440.

The support tray 404 may further comprise first and second opposing ends 448, 452, a top surface 456 extending between the first and second opposing ends 448, 452 and having a compartment 460 extending from the first end 448 toward a first end wall 464 for receiving the insert 408. The compartment 460 may include the first end wall 464 conforming to the second end 440 of the insert 408 and opposing first and second side walls 468, 472 extending from the first end wall 464 toward the first end 448 of the support tray 404 and conforming to the first and second opposing sides 442, 444 of the insert 408.

The first and second opposing ends 438, 440 of the insert 408 have different shapes to ensure that a user will correctly orient the insert 408 within the support tray 404 during use. In the implementations shown in FIGS. 5-7 and 9, the shape of the first end 438 of the insert 408 is rectangular and the shape and the second end 440 of the insert 408 is curved.

The top surface 456 of the support tray 404 may include an elongated channel 476 extending from the second end 452 of the support tray 404 toward a second end wall 478, and a white calibration strip (not shown) may be received in the elongated channel 476 of the support tray 404. The white calibration strip may be used by the apparatus 100 to determine a white balance so that any colorimetric analysis performed using the apparatus 100 may be properly calibrated. The elongated channel 476 may be recessed with respect to the top surface 456. The top surface 456 of the support tray 404 may also include a sloped surface 480 extending from a center of the first end wall 464 of the compartment 460 toward the second end wall 478 of the elongated channel 476, the sloped surface 480 being sloped downwardly toward the compartment 460. The first and second surfaces 412, 416 of the insert 408 may include valleys or depressions 484 that correspond to the sloped surface 480 of the support tray 404 when the insert 408 is positioned within the compartment 460. The sloped surface 480 may aid in the proper optical inspection of the reagent strip 300 and the reagent cassette 312 by providing a guide for properly aligning and positioning the insert 408 within the support tray 404.

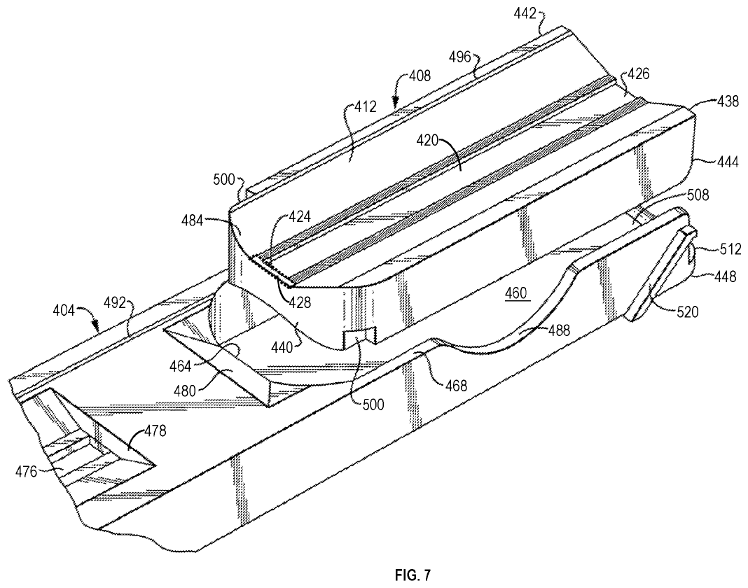

As shown in FIGS. 5-8, the side walls 468, 472 of the compartment 460 of the support tray 404 may include cut-outs 488 for allowing the sides 442, 444 of the insert 408 to be grasped when the insert 408 is positioned within the compartment 460. The support tray 404 may also include an elongated guide 492 extending from the compartment 460 toward the second end 452 of the support tray 404, and the first and second surfaces 412, 416 of the insert 408, as shown in FIGS. 5-7 and 9, may include elongated guides 496 that correspond to the elongated guide 492 of the support tray 404 when the insert 408 is positioned within the compartment 460. The elongated guides 492, 496 may be grooves that receive a wheel (not shown) mounted within the apparatus 100 of FIG. 1 that helps to smoothly guide, extend, and retract the tray assembly 400 relative to the housing 104 of the apparatus 100. The insert 408 also defines sinks 500 in the elongated guides 496 of the first and second surfaces 412, 416, that prevent excess bodily fluids from flowing from the insert 408 and down the guide 492 of the support tray 404 (and thus into the apparatus 100). The sinks 500, therefore, retain excess bodily fluid overflow and help to prevent contamination of the apparatus 100 by excess bodily fluids contained on the insert 408, the reagent strip 300, or the reagent cassette 312.

As shown in FIGS. 5-6 and 8, the compartment 460 may include stops 504 for engaging the insert 408 when the insert 408 is positioned within the compartment 460 to prevent the insert 408 from sliding out of the compartment 460. In the implementations shown, the stops 504 are positioned so that they engage the first end 438 of the insert 408 when the insert 408 is positioned within the compartment 460. The support tray 404 may also include a lower surface 508 arranged at and positioned to border the first end 448 and having a lip 512 for catching and containing excess fluid leaking from the insert 408 when the insert 408 is positioned in the compartment 460. The lower surface 508 and the lip 512, therefore, also help to prevent contamination of the interior of the apparatus 100 by excess bodily fluids contained on the insert 408 or the reagent strip 300 or reagent cassette 312.

As shown in FIGS. 5-6, a notch 516 may be provided in the side wall 472 of the support tray 404. The notch 516 may be used during a detection phase of the apparatus 100 for detection of proper positioning of the support tray 404 by another detector of the apparatus 100 shown in FIG. 1 when the support tray 404 is inserted into the housing 104 of the apparatus 100.

As shown in FIG. 5, the support tray 404 may further include a cam surface 520. The cam surface 520 may be used to open the door 112 of the apparatus 100 shown in FIG. 1 when the support tray 404 is extended out from the housing 104 of the apparatus 100 and may cause the door 112 to close when the support tray 404 is retracted into the housing 104 of the apparatus 100. Closing the door 112 during the detection phase may prevent ambient light from entering into the housing 104 of the apparatus 100 and causing an untoward or inaccurate result. In the implementation shown in FIG. 7, the cam surface 520 may extend from the first side wall 468 of the support tray 404.

During use, the insert 408 of the tray assembly 400 may be removable from the support tray 404 and may be turned over and re-inserted into the support tray 404 depending upon which of the reagent strip 300 and the reagent cassette 312 is to be used with the tray assembly 400. Since the reagent strip 300 and the reagent cassette 312 do not directly touch the support tray 404, but are instead supported by the insert 408, the support tray 404 is less likely to be contaminated by excess bodily fluids from the reagent strip 300 and the reagent cassette 312. Instead, the insert 408 may be removed from the support tray 404 and cleaned of excess bodily fluids if necessary. In addition, the support tray 404 may be easily cleaned upon removal of the insert 408.

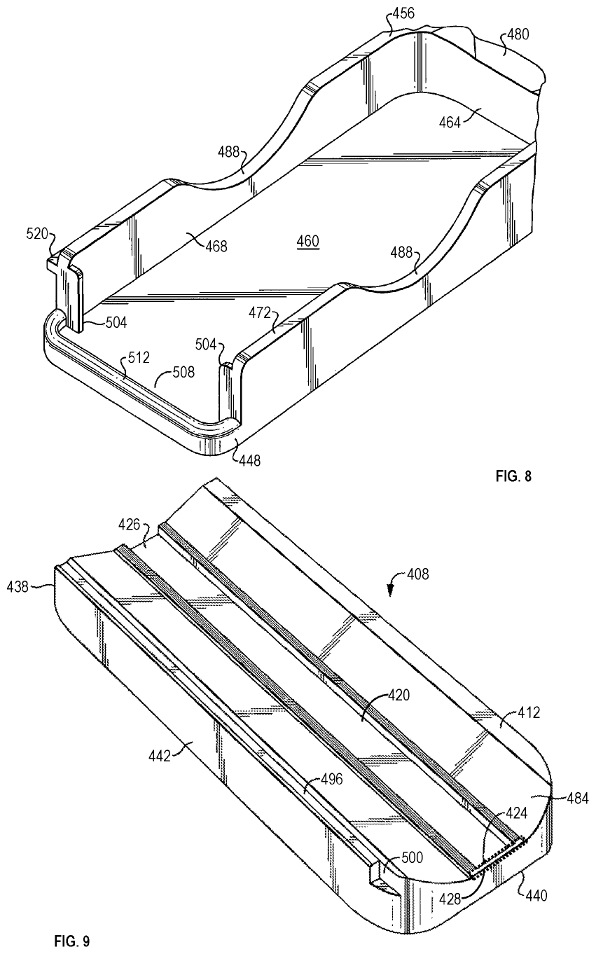

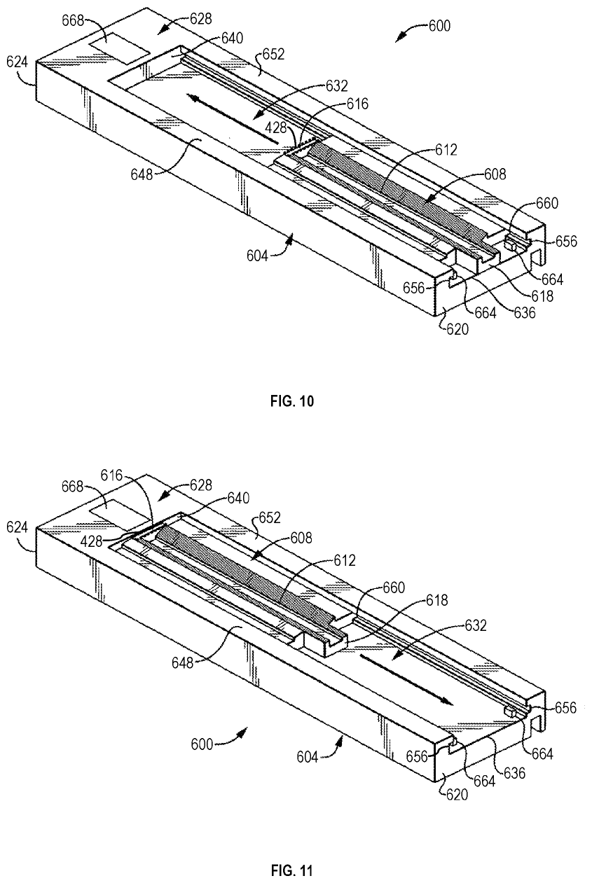

FIGS. 10-11 show another exemplary implementation of a tray assembly 600 constructed in accordance with the present disclosure for use with the apparatus 100 of FIG. 1. The tray assembly 600 may comprise a support tray 604 and an insert 608 received for movement within the support tray 604. The insert 608 may be movable between a first position (shown in FIG. 10) and a second position (shown in FIG. 11) via, for example, slidable movement within the support tray 604. In FIG. 10, the insert 608 is shown in the first position so that the reagent strip 300 may be inserted into the insert 608 and used with the tray assembly 600. The insert 608 may have an elongated channel 612 (similar to the elongated channel 420 shown in FIG. 5) sized to accommodate the reagent strip 300, an end wall 616 closing the elongated channel 612 at an end of the insert 608, and an open end 618 such that the reagent strip 300 may be slidingly inserted into the insert 608. In FIG. 11, the insert 608 is shown in the second position allowing a reagent cassette 312 to be inserted into the support tray 604.

The support tray 604 may comprise first and second opposing ends 620, 624 and a top surface 628 extending between the first and second opposing ends 620, 624 and having a compartment 632 extending from an open end 636 at the first end 620 of the support tray 604 to an end wall 640 nearer the second end 624 of the support tray 604. The insert 608 may be movably supported within the compartment 632 of the support tray 604 and movable between the first position adjacent the open end 636 of the compartment 632, as shown in FIG. 10, and the second position adjacent the end wall 640 of the compartment 632, as shown in FIG. 11. The reagent cassette 312 may be inserted into the compartment 632 between the open end 636 of the compartment 632 and the insert 608 when the insert 608 is in the second position shown in FIG. 11. As discussed further below, the reagent cassette 312 may be secured in the compartment 632 by a plurality of upwardly extending locating members 664. The open end 618 of the insert 608 may be abutted by the reagent cassette 312.

In the exemplary implementation of FIGS. 10-11, the insert 608 may be slidably movable within the compartment 632 of the support tray 604 between the first and the second positions. As shown, side walls 648, 652 of the compartment 632 of the support tray 604 may include channels 656, and sides of the insert 608 may include rails 660 received in the channels 656 for guiding the sliding movement of the insert 608 within the compartment 632. In the implementation shown in FIGS. 10-11, the insert 608 is not removable from the support tray 604. However, in some implementations, the insert 608 may be slidingly removable from the support tray 604.

The open end 636 at the first end 620 of the support tray 604 may have the locating members 664, which may be in the form of pins, for example. When the reagent strip 300 or the reagent cassette 312 is placed within the support tray 604, the locating members 664 may be positioned within a plurality of apertures or holes (not shown) formed in a bottom surface of the reagent strip 300 or the reagent cassette 312 (so that the locating members 664 may prevent the reagent strip 300 or the reagent cassette 312 from inadvertently sliding out of the compartment 632. The support tray 604 may have a conventional calibration chip 668 of a certain color, such as white, disposed in the top surface 628 of the support tray 604 to facilitate calibration in a conventional manner.

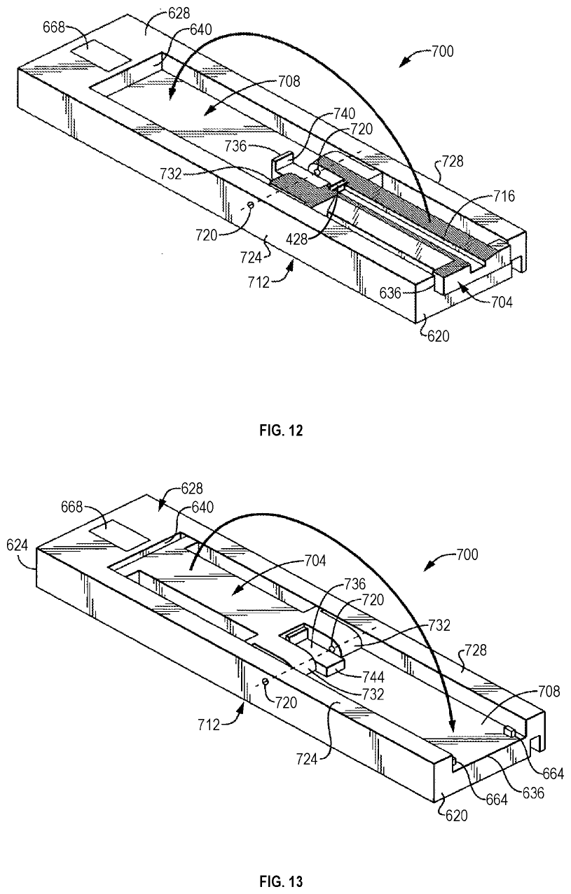

A further exemplary implementation of a tray assembly 700 constructed in accordance with the present disclosure for use with the apparatus 100 of FIG. 1 is shown in FIGS. 12-13. The tray assembly 700 is similar to the tray assembly 600 shown in FIGS. 10-11, but includes an insert 704 that is pivotally movable within a compartment 708 of a support tray 712 between a first position, shown in FIG. 12, and a second position, shown in FIG. 13. When the insert 704 is in the first position, the tray assembly 700 may be adapted for receiving the reagent strip 300 in an elongated channel 716 in a surface of the insert 704, as similarly described in FIG. 5 with respect to the elongated channel 420. When the insert 704 is in the second position, the tray assembly 700 may be adapted for receiving the reagent cassette 312 in the compartment 708 of the support tray 712. The reagent cassette 312 may be secured in the compartment 708 by the locating members 664, as similarly described in FIG. 11 with respect to the compartment 632.

The insert 704 may be pivotally mounted to the support tray 712 by two pins 720 which extend through side walls 724, 728 of the support tray 712 and through hinges 732 of the insert 704. In the implementation shown in FIGS. 12-13, the insert 704 is not removable from the support tray 712. An anchor 736 may be fixed to the floor of the compartment 708, between the hinges 732 of the insert 704, and provides an end wall 740 for the reagent strip 300 to abut and an end wall 744 for the reagent cassette 312 to abut.

Referring now to FIG. 14, shown therein is a method 800 for optically inspecting a liquid sample disposed on a liquid sample carrier, such as the reagent strip 300 and the reagent cassette 312. In some implementations, the software application 228 stored in the controller memory 224 of the controller 202, when executed by the processor 212 of the controller 202, may cause the processor 212 to perform one or more steps of the method 800 described herein. As shown in FIG. 14, the method 800 may comprise the steps of: analyzing pixels within one or more image, such as image 900 (shown in FIGS. 15-18), of a liquid sample carrier (step 804); determining a reading area position of a reading area of the liquid sample carrier within the one or more image (step 808); and analyzing pixels within the one or more image depicting the reading area to determine a presence and/or absence of a predetermined analyte in the liquid sample (step 812). This may be accomplished by comparing the color of the pixels within the reading area of the one or more image or a time-based series of images, for example, to predetermined colors and/or times stored in memory that are indicative of the presence and/or absence of a predetermined analyte.

Shown in FIG. 15 is an exemplary implementation of an image 900 of a liquid sample carrier (i.e., the reagent strip 300) captured by the sensor 206 of the optical inspection apparatus 100 and stored in the controller memory 224 shown in FIG. 2. As discussed above, in some implementations, a fiducial 428 is disposed on the end wall 424 of the first surface 412 of the insert 408 and is captured in the image with the liquid sample carrier (i.e., the reagent strip 300). The processor 212 of the apparatus 100 may be configured to analyze the image 900 to locate the fiducial 428 and thereby use the fiducial 428 as the indicator for determining the position of the reading area of the reagent strip 300.

In some implementations, during the manufacturing of the apparatus 100, a known displacement 904 between the fiducial 428 and the reagent pad area 310 is measured and data indicative of the known displacement 904 and direction to the reagent pad area 310, and thus a predetermined feature (e.g., a leading edge 905) of the reagent pad 308a is stored in the controller memory 224. Although each of the reagent pads 308 have the leading edge 905, only the reagent pad 308a is labeled for purposes of clarity. The known displacement 904 may be a number of pixels from the fiducial 428 to the leading edge 905. In some implementations, during the manufacturing of the apparatus 100, a plurality of known displacements 908 between the fiducial 428 and predetermined features, e.g., leading edges 905 each of the reagent pads 308 are measured and data indicative of the known displacements 908 is stored in the controller memory 224. In some implementations, during the manufacturing of the apparatus 100, a known displacement 909 between a first reagent pad 308a and a second reagent pad 308b is measured and data indicative of the known displacement 909 is stored in the controller memory 224. In some implementations, during the manufacturing of the apparatus 100, a plurality of known displacements 914 between each of the reagent pads 308 are measured and data indicative of the known displacements 914 is stored in the controller memory 224. For purposes of clarity, only one of the known displacements 908 and only one of the known displacements 914 is labeled with a reference character. When using the known displacements 914 to locate additional reagent pad(s) 308, a size (e.g., length) of the reagent pad(s) 308 may also be stored in the controller memory 224 and used to locate the additional reagent pad(s) 308. For example, once the location of the fiducial 428 is determined, the known displacement 904 and a direction can be used to locate the leading edge 905 of the reagent pad 308a. Then, the known size of the reagent pad 308a and the known displacement 914 can be used to locate the reagent pad 308b by adding or subtracting pixels, for example, in a known direction. This process can be repeated to locate the other reagent pads 308. Once the location of the reagent pad 308a and/or 308b has been determined, the known displacements 904 and/or 914 and/or the size of the reagent pads 308 can be used to determine the location of additional reagent pads 308.

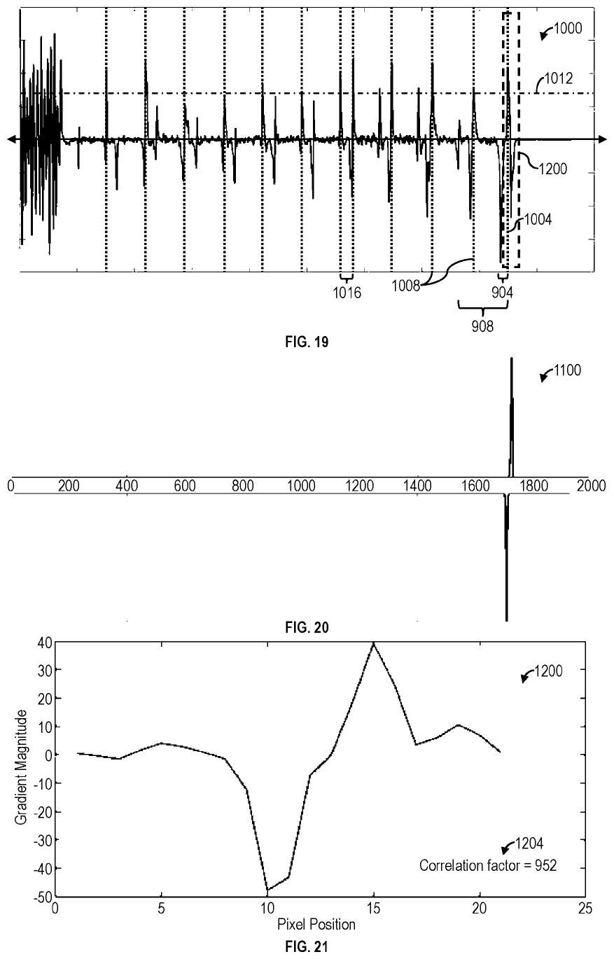

In some implementations, the step of analyzing pixels within the one or more image of the reagent strip 300 (step 804) may comprise analyzing pixels within the one or more image to determine the location of an indicator (e.g., the fiducial 428 or the symbols 910) within the one or more image. Analyzing pixels within the one or more image may further comprise computing a one-dimensional gradient representation 1000 (hereinafter the “1D gradient 1000”) (shown in FIG. 19) of the one or more image. Computing the 1D gradient 1000 may comprise computing an average value (e.g., an intensity, a plurality of color values (e.g., averaging the red, green, and blue channels of the pixels to obtain a gray channel for each pixel in one of the rows), a saturation, etc.) for each pixel position along an axis 912 aligned with the reagent strip 300 and plotting the average values as shown in FIG. 19.

In some implementations, the one or more image may be converted to a different color space from RGB, such as HSV or YCbCr, or any other format suitable for processing, which are well known in literature.

In some Implementations, the one or more image may be pre-processed by passing the one or more image through at least one filter, to enhance the Region of Interest(s) in the one or more image. Exemplary filters that may be used to enhance the Region of Interest may be a gaussian low pass filter, a Butterworth low pass filter, an edge detection filter, or the like which are well known in literature.

In some implementations, the step of analyzing pixels within the one or more image (step 804) may further comprise scanning the 1D gradient 1000 in a predetermined direction (e.g., from right to left, as shown in FIG. 19, or from left to right) to determine a first local maximum/minimum position 1004 of a first local maximum/minimum of the 1D gradient 1000. Because the fiducial 428 is preferably provided with a color value that contrasts with the first surface 412 of the insert 408, the location of the fiducial 428 may be determined by the first local maximum/minimum position 1004. Determining the first local maximum/minimum position 1004 may include computing a first-order differential of the 1D gradient 1000 and determining a first point at which the first-order differential transitions from positive values to negative values or from negative values to positive values. However, it should be understood that determining the first local maximum/minimum position 1004 may be accomplished in any number of conventional ways known to persons having ordinary skill in the art.

In implementations where the known displacement 904 and predetermined direction are stored in the controller memory 224, the step of determining the reading area position of the reading area of the reagent strip 300 within the one or more image (step 808) may be further defined as analyzing pixels within the one or more image to determine the reading area position of the reading area, wherein the reading area is the reagent pad area 310, by applying (i.e., adding) the known displacement 904 and the predetermined direction to the first local maximum/minimum position 1004.

In implementations where the known displacements 908 are stored in the controller memory 224, the step of determining the reading area position of the reading area of the reagent strip 300 within the one or more image (step 808) may be further defined as analyzing pixels within the one or more image to determine a plurality of reading area positions of a plurality of reading areas, wherein the plurality of reading areas are the plurality of reagent pads 308, by applying (i.e., adding) the known displacements 908 to the first local maximum/minimum position 1004. The known displacements 908 may be a number of pixels within the one or more image from the location of the indicator.

In implementations where the known displacement(s) 909 is/are also stored in the controller memory 224, the step of determining the reading area position of the reading area of the reagent strip 300 within the one or more image (step 808) may be further defined as analyzing pixels within the one or more image to determine a first reading area position of a first reading area of the reagent strip 300 within the one or more image, wherein the first reading area is a first reagent pad 308a. In such implementations, the step of determining the reading area position of the reading area of the reagent strip 300 within the one or more image (step 808) may further comprise analyzing pixels within the one or more image to determine second reading area position of a second reading area, wherein the second reading area is a second reagent pad 308b, by applying (e.g.,, adding or subtracting) the known displacement 909 and predetermined direction to the determined first reading area position. Thus, assuming the reagent strip includes 10 reagent pads 308, the controller memory 224 may store nine known displacements 909 and one or more direction to assist the processor 212 in locating the reading areas for the other reagent pads 308, after the first reading area position has been located. The known displacements 909 may be a number of pixels within the one or more image from the location of the first reading area.

In some implementations where the known displacement 909 is also stored in the controller memory 224, the step of determining the reading area position of the reading area of the reagent strip 300 within the one or more image (step 808) may further comprise analyzing pixels within the one or more image to determine a plurality of additional reading area positions of a plurality of additional reading areas, wherein the plurality of additional reading areas are the plurality of reagent pads 308 (excluding the first reagent pad 308a and the second reagent pad 308b), by continuously applying (i.e., adding) the known displacement 909 to the second reading area position, a third reading area position, etc.

In implementations where the known displacements 914 are also stored in the controller memory 224, the step of determining the reading area position of the reading area of the reagent strip 300 within the one or more image (step 808) may further comprise determining a plurality of additional reading area positions of a plurality of additional reading areas, wherein the plurality of additional reading areas are the plurality of reagent pads 308 (excluding the first reagent pad 308a and the second reagent pad 308b), by applying a respective one of the known displacements 914 to the second reading area position, the third reading area position, etc.

In other implementations, the step of determining the reading area position of the reading area of the reagent strip 300 within the one or more image (step 808) may be further defined as scanning the 1D gradient 1000 in the predetermined direction to determine a plurality of additional local maximum/minimum positions 1008 of a plurality of additional local maxima/minima of the 1D gradient 1000. In such implementations, the plurality of reading area positions of the plurality of reading areas may be determined by the plurality of additional local maximum/minimum positions 1008. Determining the plurality of additional local maximum/minimum positions 1008 may be based on additional constraints, such as a predetermined threshold 1012 and/or a minimum distance 1016 between each of the additional local maximum/minimum positions 1008. In some implementations, determining the plurality of additional local maximum/minimum positions 1008 may comprise computing a first-order differential of the 1D gradient 1000 and determining the points at which the first-order differential transitions from positive values to negative values, such points corresponding to the additional local maximum/minimum positions 1008. However, it should be understood that determining the plurality of additional local maximum/minimum positions 1008 may be accomplished in any number of conventional ways known to persons having ordinary skill in the art.

In some implementations, the method 800 further comprises determining that the determined reading area position has a homogeneity value within a predetermined range. For example, where a magnitude of a portion the 1D gradient 1000 in the vicinity of the determined reading area position is less than a predetermined threshold (e.g., a value of 2), the reading area position may be determined to be legitimate. Conversely, where the magnitude of the portion of the 1D gradient 1000 in the vicinity of the determined reading area position is greater than the predetermined threshold, the reading area position may be determined to be erroneous, in which case the method 800 further comprises discarding the determined reading area position and attempting to determine a legitimate reading area position. Such a homogeneity check may be performed for each of the plurality of reading area positions.

In some implementations, in order to confirm the location of the fiducial 428, the method 800 further comprises: storing a template gradient 1100 (shown in FIG. 20) in a memory, the template gradient 1100 representing a pure white indicator being surrounded by pure black on either side; computing a correlation factor 1204 (shown in FIG. 21) between a portion 1200 of the 1D gradient 1000 in the vicinity of the fiducial 428 and the template gradient 1100, wherein the correlation factor 1204 is directly proportional to the correlation between the portion 1200 of the 1D gradient 1000 in the vicinity of the fiducial 428 and the template gradient 1100; and determining that the correlation factor 1204 is greater than a predetermined threshold, thus ensuring confidence in the location of the fiducial 428 and the reading area position(s). Where it is determined that the correlation factor 1204 is less than a predetermined threshold, the method 800 may comprise alerting a user that maintenance may be required.

In some implementations, computing the correlation factor comprises computing a sum of products for the template gradient 1100 and the portion 1200 of the 1D gradient 1000 in the vicinity of the fiducial 428. However, it should be understood that computing the correlation factor 1204 may be accomplished in any number of conventional ways known to persons having ordinary skill in the art.

As discussed above, in some implementations, symbols 910 may be disposed on the upper surface 311 of the substrate 304 of the reagent strip 300. In such implementations, the processor 212 running the software application 228 of the apparatus 100 may use the symbols 910 (as shown in FIG. 15), rather than the fiducial 428, as an indicator for determining a position of the reading area of the reagent strip 300. In such implementations, the step of analyzing pixels within the one or more image of the reagent strip 300 (step 804) may comprise the processor 212 analyzing pixels within the one or more image to determine the location of an indicator (i.e., the symbols 910) within the one or more image.

Analyzing the pixels within the one or more image to determine the location of the symbols 910 may comprise performing one or more image processing-based algorithm, analysis, or operation. Nonlimiting examples of the one or more image processing-based algorithm, analysis, or operation include an optical character recognition algorithm, a Hough transform, a connected component analysis, or a machine learning or deep learning model trained on a dataset consisting of images of reagent strips 300 having the symbols 910. Once the location of the symbols 910 are determined, then the relative locations of the reagent pads 308 may be determined as described above using a known displacement from the symbols 910 to a particular reagent pad 308, known displacement(s) between the reagent pads and combinations thereof. Then, the colors of pixels within the one or more image depicting the reading area of the reagent pads 308 are analyzed to determine a presence and/or absence of a predetermined analyte in the liquid sample. In other embodiments, a machine learning or deep learning model trained on a dataset consisting of images of reagent strips 300 may be used to directly determine the location of the reagent pads 308 in the one or more image.

Shown in FIGS. 16-18 are other exemplary implementations of the image 900 of the liquid sample carrier (i.e., the reagent cassette 312) captured by the sensor 206 of the optical inspection apparatus 100 shown in FIG. 1. As discussed above, in some implementations, symbols 916 (shown in FIG. 16), a luminescent material 918 (shown in FIG. 17), or a colored region 920 (shown in FIG. 18) may be disposed on the upper surface 320 of the reagent cassette 312.

In some implementations, during the manufacturing of the apparatus 100, a plurality of known displacements 922 between one or more of the symbols 916 and the window 324 are measured and data indicative of the known displacements 922 is stored in the controller memory 224. In some implementations, during the manufacturing of the apparatus 100, a plurality of known displacements 924 between one or more structural feature of the reagent cassette 312 (e.g., the first portion 328, the second portion 332, the curved end wall 336, and/or the indents 340a, 340b) (hereinafter the “structural features”) and the window 324 are measured and data indicative of the known displacements 924 is stored in the controller memory. For purposes of clarity, only one of the known displacements 922 and only one of the known displacements 924 are labeled with reference characters. As shown in FIG. 16, each of the known displacements 922 and the known displacements 924 may be an ordered pair having perpendicular x (e.g., horizontal) component and y (e.g., vertical) components.

In some implementations, the processor 212 running the software application 228 of the apparatus 100 may use one or more of the symbols 916, the luminescent material 918, the colored region 920, and the structural features as an indicator for determining a position of the reading area of the reagent cassette 312. In such implementations, the step of analyzing pixels within the one or more image of the reagent cassette 312 (step 804) may comprise the processor 212 analyzing pixels within the one or more image to determine the location of an indicator (i.e., the symbols 916, the luminescent material 918, the colored region 920, or the structural features) within the one or more image.

Determining the location of the symbols 916 or the colored region 920 may comprise performing one or more image processing-based algorithm, analysis, or operation. Nonlimiting examples of the one or more image processing-based algorithm, analysis, or operation include an optical character recognition algorithm, a Hough transform, a connected component analysis, or a machine learning or deep learning model trained on a dataset consisting of images of reagent cassettes 312.

Determining the location of the luminescent material 918 may comprise the processor 212 actuating the light source 204 to illuminate the luminescent material 918 with a particular wavelength of the electromagnetic spectrum and actuating the sensor 206 to capture the one or more image such that the luminescent material 918 appears different.

In some implementations, rather than using the symbols 916, the luminescent material 918, or the colored region 920 as the indicator, the processor 212 of the apparatus 100 may be configured to analyze the one or more image to identify one or more of the structural features as the indicator.

In implementations where one or more of the symbols 916 is used as the indicator, the step of determining the reading area position of the reading area of the liquid sample carrier (step 808) may be further defined as analyzing pixels within the one or more image to determine the reading area position of the reading area, wherein the reading area is the window 324, by applying (i.e., adding) the known displacements 922 to the determined location(s) of the symbols 916.

In implementations where one or more of the luminescent material 918 and the colored region 920 is used as the indicator, the step of determining the reading area position of the reading area of the liquid sample carrier (step 808) may be further defined as analyzing pixels within the one or more image to determine the reading area position of the reading area, wherein the reading area is the window 324, by identifying a region surrounded by the luminescent material 918 and/or the colored region 920.

In implementations where one or more of the structural features is used as the indicator, the step of determining the reading area position of the reading area of the liquid sample carrier (step 808) may be further defined as analyzing pixels within the one or more image to determine the reading area position of the reading area, wherein the reading area is the window 324, by applying (i.e., adding) the known displacements 924 to the determined location(s) of the structural features.

From the above description, it is clear that the inventive concepts disclosed and claimed herein are well adapted to carry out the objects and to attain the advantages mentioned herein, as well as those inherent in the invention. While exemplary embodiments of the inventive concepts have been described for purposes of this disclosure, it will be understood that numerous changes may be made which will readily suggest themselves to those skilled in the art and which are accomplished within the spirit of the inventive concepts disclosed and claimed herein.

### Non-Limiting Illustrative Embodiments

The following is a number list of non-limiting illustrative embodiments of the inventive concept disclosed herein:
Illustrative embodiment 1. A method, comprising: analyzing, by a processor, pixels within an image of a liquid sample carrier to determine a location of an indicator within the image, the liquid sample carrier having a liquid sample disposed thereon; determining, by the processor, a reading area position of a reading area of the liquid sample carrier within the image based at least in part on the location of the indicator determined by analyzing pixels within the image; and analyzing, by the processor, pixels within the image depicting the reading area to determine a presence and/or absence of a predetermined analyte in the liquid sample.
Illustrative embodiment 2. The method of illustrative embodiment 1, wherein analyzing pixels within the image to determine the location of the indicator within the image is further defined as analyzing pixels within the image to determine the location of the indicator within the image, wherein the indicator is separate from the liquid sample carrier.
Illustrative embodiment 3. The method of any of illustrative embodiments 1-2, wherein analyzing pixels within the image to determine the location of the indicator within the image is further defined as analyzing pixels within the image to determine the location of the indicator within the image, wherein the indicator is disposed on a surface of the liquid sample carrier.
Illustrative embodiment 4. The method of any of illustrative embodiments 1-3, wherein analyzing pixels within the image to determine the location of the indicator within the image comprises computing, by the processor, a one-dimensional gradient representation of the image, and scanning, by the processor, the one-dimensional gradient representation of the image in a predetermined direction to determine a first local maximum/minimum position of a first local maximum/minimum of the one-dimensional gradient representation of the image, wherein the location of the indicator is determined by the first local maximum/minimum position.
Illustrative embodiment 5. The method of any of illustrative embodiments 1-4, wherein determining the reading area position of the reading area of the liquid sample carrier within the image is further defined as analyzing, by the processor, pixels within the image to determine a plurality of reading area positions of a plurality of reading areas of the liquid sample carrier.
Illustrative embodiment 6. The method of any one of the preceding illustrative embodiments, wherein determining the plurality of reading area positions of the plurality of reading areas is further defined as determining, by the processor, the plurality of reading area positions based at least in part on a plurality of known displacements between the location of the indicator and each of the plurality of reading area positions.
Illustrative embodiment 7. The method of any one of the preceding illustrative embodiments, wherein determining the plurality of reading area positions of the plurality of reading areas is further defined as determining, by the processor, a plurality of additional local maximum/minimum positions of a plurality of additional local maxima of the one-dimensional gradient representation, wherein each of the plurality of reading area positions is determined based on a respective one of the plurality of additional local maximum/minimum positions.
Illustrative embodiment 8. The method of any one of the preceding illustrative embodiments, wherein determining the plurality of reading area positions of the plurality of reading areas is further defined as determining, by the processor, a second local maximum/minimum position of a second local maximum/minimum of the one-dimensional gradient representation, wherein a first reading area position of a first reading area is determined based on the second local maximum/minimum position, and determining, by the processor, a plurality of additional reading area positions of a plurality of additional reading areas based at least in part on a plurality of known displacements between the first reading area position and each of the plurality of additional reading area positions.
Illustrative embodiment 9. The method of any one of the preceding illustrative embodiments, wherein the indicator is one or more symbol disposed on the surface of the liquid sample carrier, and determining the location of the indicator is further defined as performing, by the processor, an optical character recognition on the image to detect one or more symbol location of the one or more symbol, wherein the location of the indicator is determined by the one or more symbol location.
Illustrative embodiment 10. The method of any one of the preceding illustrative embodiments, wherein the indicator is one or more colored region disposed on the surface of the liquid sample carrier, the colored region having a predetermined color value, and determining the location of the indicator is further defined as detecting, by the processor, the predetermined color value in the pixels within the image.
Illustrative embodiment 11. The method of any one of the preceding illustrative embodiments, wherein the indicator is a material configured to appear bright or dark when exposed to a particular wavelength of the electromagnetic spectrum, and determining the location of the indicator is further defined as illuminating, by the processor, the liquid sample carrier with the particular wavelength of the electromagnetic spectrum, and determining, by the processor, the location of the indicator based at least in part on an appearance of the indicator when illuminated with the particular wavelength of the electromagnetic spectrum.
Illustrative embodiment 12. An optical inspection apparatus, comprising: a housing having an interior encompassing an inspection location; an indicator located within the inspection location; a light source configured to illuminate the inspection location within the housing; a tray assembly configured to receive a liquid sample carrier, the tray assembly being insertable within the inspection location of the housing; a sensor configured to capture an image of the inspection location of the housing including the indicator; and a controller having a processor operable to execute processor-executable code that when executed by the processor causes the processor to: analyze pixels within the image captured by the sensor to determine a location of the indicator within the image; determine a reading area position of a reading area within the image based at least in part on the location of the indicator determined by analyzing pixels within the image; and analyze pixels within the reading area of the image to determine a presence and/or absence of a predetermined analyte.
Illustrative embodiment 13. The optical inspection apparatus of any one of the preceding illustrative embodiments, wherein the indicator is on the tray assembly.
Illustrative embodiment 14. The optical inspection apparatus any one of the preceding illustrative embodiments, wherein the indicator is not on the tray assembly.
Illustrative embodiment 15. The optical inspection apparatus of any one of the preceding illustrative embodiments, wherein analyzing pixels within the image to determine the location of the indicator within the image comprises computing a one-dimensional gradient representation of the image, and scanning the one-dimensional gradient representation of the image in a predetermined direction to determine a first local maximum/minimum position of a first local maximum/minimum of the one-dimensional gradient representation of the image, wherein the location of the indicator is determined by the first local maximum/minimum position.
Illustrative embodiment 16. The optical inspection apparatus of any one of the preceding illustrative embodiments, wherein determining the reading area position of the reading area of the liquid sample carrier within the image is further defined as analyzing pixels within the image a predetermined distance and direction away from the location of the indicator.
Illustrative embodiment 17. The optical inspection apparatus of any one of the preceding illustrative embodiments, wherein determining the reading area position is defined further as determining a plurality of reading area positions of a plurality of reading areas by analyzing pixels at a plurality of known displacements from the location of the indicator and each of the plurality of reading area positions.
Illustrative embodiment 18. The optical inspection apparatus of any one of the preceding illustrative embodiments, wherein determining the plurality of reading area positions of the plurality of reading areas is further defined as determining a plurality of additional local maximum/minimum positions of a plurality of additional local maxima/minima of the one-dimensional gradient representation, wherein each of the plurality of reading area positions is determined based on a respective one of the plurality of additional local maximum/minimum positions.
Illustrative embodiment 19. The optical inspection apparatus of any one of the preceding illustrative embodiments, wherein determining the reading area position of the reading area within the image is further defined as determining a plurality of reading area positions of a plurality of reading areas within the image, wherein determining the plurality of reading area positions of the plurality of reading areas within the image comprises determining a second local maximum/minimum position of a second local maximum/minimum of the one-dimensional gradient representation, wherein a first reading area position of a first reading area is determined based on the second local maximum/minimum position, and determining, by the processor, a plurality of additional reading area positions of a plurality of additional reading areas based at least in part on a plurality of known displacements between the first reading area position and each of the plurality of additional reading area positions.
Illustrative embodiment 20. An optical inspection apparatus, comprising: a housing having an interior encompassing an inspection location; a liquid sample carrier having an indicator; a light source configured to illuminate the inspection location within the housing; a tray assembly receiving the liquid sample carrier, the tray assembly being insertable within the inspection location of the housing; a sensor configured to capture an image of the inspection location of the housing including the indicator; and a controller having a processor operable to execute processor-executable code that when executed by the processor causes the processor to: analyze pixels within the image captured by the sensor to determine a location of the indicator within the image; determine a reading area position of a reading area within the image based at least in part on the location of the indicator determined by analyzing pixels within the image; and analyze pixels within the reading area of the image to determine a presence and/or absence of a predetermined analyte.
Illustrative embodiment 21. The optical inspection apparatus any one of the preceding illustrative embodiments, wherein the liquid sample carrier has a surface, and wherein the indicator is one or more symbol disposed on the surface of the liquid sample carrier, and determining the location of the indicator is further defined as performing an optical character recognition on the image to detect one or more symbol location of the one or more symbol, wherein the location of the indicator is determined by the one or more symbol location.
Illustrative embodiment 22. The optical inspection apparatus of any one of the preceding illustrative embodiments, wherein the liquid sample carrier has a surface, and wherein the indicator is one or more colored region disposed on the surface of the liquid sample carrier, the colored region having a predetermined color value, wherein the location of the indicator is determined based at least in part on detecting the predetermined color value in the pixels within the image.
Illustrative embodiment 23. The optical inspection apparatus of any one of the preceding illustrative embodiments, wherein the liquid sample carrier has a surface, and wherein the indicator is a material on the surface of the liquid sample carrier and configured to appear bright or dark when exposed to a particular wavelength of the electromagnetic spectrum, and determining the location of the indicator is further defined as illuminating, by the light source, the liquid sample carrier with the particular wavelength of the electromagnetic spectrum, wherein the location of the indicator is determined based at least in part on an appearance of the indicator when illuminated with the particular wavelength of the electromagnetic spectrum.

What is claimed is:

1. A method, comprising:
analyzing, by a processor, pixels within an image of a liquid sample carrier to determine a location of an indicator within the image, the liquid sample carrier having a liquid sample disposed thereon;
determining, by the processor, a reading area position of a reading area of the liquid sample carrier within the image based at least in part on the location of the indicator determined by analyzing pixels within the image; and
analyzing, by the processor, pixels within the image depicting the reading area to determine a presence and/or absence of a predetermined analyte in the liquid sample.

2. The method of claim 1, wherein analyzing pixels within the image to determine the location of the indicator within the image is further defined as analyzing pixels within the image to determine the location of the indicator within the image, wherein the indicator is separate from the liquid sample carrier.

3. The method of claim 1, wherein analyzing pixels within the image to determine the location of the indicator within the image is further defined as analyzing pixels within the image to determine the location of the indicator within the image, wherein the indicator is disposed on a surface of the liquid sample carrier.

4. The method of claim 1, wherein analyzing pixels within the image to determine the location of the indicator within the image comprises computing, by the processor, a one-dimensional gradient representation of the image, and scanning, by the processor, the one-dimensional gradient representation of the image in a predetermined direction to determine a first local maximum/minimum position of a first local maximum/minimum of the one-dimensional gradient representation of the image, wherein the location of the indicator is determined by the first local maximum/minimum position.

5. The method of claim 4, wherein determining the reading area position of the reading area of the liquid sample carrier within the image is further defined as analyzing, by the processor, pixels within the image to determine a plurality of reading area positions of a plurality of reading areas of the liquid sample carrier.

6. The method of claim 5, wherein determining the plurality of reading area positions of the plurality of reading areas is further defined as determining, by the processor, the plurality of reading area positions based at least in part on a plurality of known displacements between the location of the indicator and each of the plurality of reading area positions.

7. The method of claim 5, wherein determining the plurality of reading area positions of the plurality of reading areas is further defined as determining, by the processor, a plurality of additional local maximum/minimum positions of a plurality of additional local maxima of the one-dimensional gradient representation, wherein each of the plurality of reading area positions is determined based on a respective one of the plurality of additional local maximum/minimum positions.

8. The method of claim 5, wherein determining the plurality of reading area positions of the plurality of reading areas is further defined as determining, by the processor, a second local maximum/minimum position of a second local maximum/minimum of the one-dimensional gradient representation, wherein a first reading area position of a first reading area is determined based on the second local maximum/minimum position, and determining, by the processor, a plurality of additional reading area positions of a plurality of additional reading areas based at least in part on a plurality of known displacements and direction between the first reading area position and each of the plurality of additional reading area positions.

9. The method of claim 3, wherein the indicator is one or more symbol disposed on the surface of the liquid sample carrier, and determining the location of the indicator is further defined as performing, by the processor, an optical character recognition on the image to detect one or more symbol location of the one or more symbol, wherein the location of the indicator is determined by the one or more symbol location.

10. The method of claim 3, wherein the indicator is one or more colored region disposed on the surface of the liquid sample carrier, the colored region having a predetermined color value, and determining the location of the indicator is further defined as detecting, by the processor, the predetermined color value in the pixels within the image.

11. The method of claim 3, wherein the indicator is a material configured to appear different when exposed to a particular wavelength of an electromagnetic spectrum, and determining the location of the indicator is further defined as illuminating, by the processor, the liquid sample carrier with the particular wavelength of the electromagnetic spectrum, and determining, by the processor, the location of the indicator based at least in part on an appearance of the indicator when illuminated with the particular wavelength of the electromagnetic spectrum.

12. The method of claim 1, wherein determining a location of the indicator within the image is defined further as confirming the location of the indicator with a template gradient stored in a non-transitory memory.

13. The method of claim 12, wherein confirming the location of the indicator with the template gradient is defined further as computing a correlation factor between a determined location of the indicator within the image and the template gradient, and further comprising issuing an alert when the correlation factor is less than a predetermined threshold.

14. An optical inspection apparatus, comprising:
a housing having an interior encompassing an inspection location;
an indicator located within the inspection location;
a light source configured to illuminate the inspection location within the housing;
a tray assembly configured to receive a liquid sample carrier, the tray assembly being insertable within the inspection location of the housing;
a sensor configured to capture an image of the inspection location of the housing including the indicator; and
a controller having a processor operable to execute processor-executable code that when executed by the processor causes the processor to:
analyze pixels within the image captured by the sensor to determine a location of the indicator within the image;
determine a reading area position of a reading area within the image based at least in part on the location of the indicator determined by analyzing pixels within the image; and
analyze pixels within the reading area of the image to determine a presence and/or absence of a predetermined analyte.

15. The optical inspection apparatus of claim 14, wherein the indicator is on the tray assembly.

16. The optical inspection apparatus of claim 14, wherein the indicator is not on the tray assembly.

17. The optical inspection apparatus of claim 14, wherein analyzing pixels within the image to determine the location of the indicator within the image comprises computing a one-dimensional gradient representation of the image, and scanning the one-dimensional gradient representation of the image in a predetermined direction to determine a first local maximum/minimum position of a first local maximum/minimum of the one-dimensional gradient representation of the image, wherein the location of the indicator is determined by the first local maximum/minimum position.

18. The optical inspection apparatus of claim 17, wherein determining the reading area position of the reading area of the liquid sample carrier within the image is further defined as analyzing pixels within the image a predetermined distance and direction away from the location of the indicator.

19. The optical inspection apparatus of claim 18, wherein determining the reading area position is defined further as determining a plurality of reading area positions of a plurality of reading areas by analyzing pixels at a plurality of known displacements from the location of the indicator and each of the plurality of reading area positions.

20. The optical inspection apparatus of claim 19, wherein determining the plurality of reading area positions of the plurality of reading areas is further defined as determining a plurality of additional local maximum/minimum positions of a plurality of additional local maxima/minima of the one-dimensional gradient representation, wherein each of the plurality of reading area positions is determined based on a respective one of the plurality of additional local maximum/minimum positions.

21. The optical inspection apparatus of claim 17, wherein determining the reading area position of the reading area within the image is further defined as determining a plurality of reading area positions of a plurality of reading areas within the image, wherein determining the plurality of reading area positions of the plurality of reading areas within the image comprises determining a second local maximum/minimum position of a second local maximum/minimum of the one-dimensional gradient representation, wherein a first reading area position of a first reading area is determined based on the second local maximum/minimum position, and determining, by the processor, a plurality of additional reading area positions of a plurality of additional reading areas based at least in part on a plurality of known displacements and direction between the first reading area position and each of the plurality of additional reading area positions.

22. The optical inspection apparatus of claim 14, wherein determining a location of the indicator within the image is defined further as confirming the location of the indicator with a template gradient stored in a non-transitory memory.

23. The method of claim 22, wherein confirming the location of the indicator with the template gradient is defined further as computing a correlation factor between a determined location of the indicator within the image and the template gradient, and further comprising issuing an alert when the correlation factor is less than a predetermined threshold.

24. An optical inspection apparatus, comprising:
a housing having an interior encompassing an inspection location;
a liquid sample carrier having an indicator;
a light source configured to illuminate the inspection location within the housing;
a tray assembly receiving the liquid sample carrier, the tray assembly being insertable within the inspection location of the housing;
a sensor configured to capture an image of the inspection location of the housing including the indicator; and
a controller having a processor operable to execute processor-executable code that when executed by the processor causes the processor to:
analyze pixels within the image captured by the sensor to determine a location of the indicator within the image;
determine a reading area position of a reading area within the image based at least in part on the location of the indicator determined by analyzing pixels within the image; and
analyze pixels within the reading area of the image to determine a presence and/or absence of a predetermined analyte.

25. The optical inspection apparatus of claim 24, wherein the liquid sample carrier has a surface, and wherein the indicator is one or more symbol disposed on the surface of the liquid sample carrier, and determining the location of the indicator is further defined as performing an optical character recognition on the image to detect one or more symbol location of the one or more symbol, wherein the location of the indicator is determined by the one or more symbol location.

26. The optical inspection apparatus of claim 24, wherein the liquid sample carrier has a surface, and wherein the indicator is one or more colored region disposed on the surface of the liquid sample carrier, the colored region having a predetermined color value, wherein the location of the indicator is determined based at least in part on detecting the predetermined color value in the pixels within the image.

27. The optical inspection apparatus of claim 24, wherein the liquid sample carrier has a surface, and wherein the indicator is a material on the surface of the liquid sample carrier and configured to appear different when exposed to a particular wavelength of an electromagnetic spectrum, and determining the location of the indicator is further defined as illuminating, by the light source, the liquid sample carrier with the particular wavelength of the electromagnetic spectrum, wherein the location of the indicator is determined based at least in part on an appearance of the indicator when illuminated with the particular wavelength of the electromagnetic spectrum.
